(19) United States
(12) Patent Application Publication
(10) Pub. No.: US 2013/0199094 A1
(43) Pub. Date: Aug. 8, 2013

(54) CONTROLLED GATE SYSTEM WITH ELECTROMAGNETIC LOCKING MECHANISM

(71) Applicants: Jerome Lachance, St. Martin (CA); Yvan Mercier, Sainte-Clotilde-de-Beauce (CA); René Bolduc, Sainte-Clotilde-de-Beauce (CA)

(72) Inventors: Jerome Lachance, St. Martin (CA); Yvan Mercier, Sainte-Clotilde-de-Beauce (CA); René Bolduc, Sainte-Clotilde-de-Beauce (CA)

(21) Appl. No.: 13/364,398

(22) Filed: Feb. 2, 2012

(51) Int. Cl. E05F 15/20; E05B 47/02; G08B 13/08; E06B 3/36

(52) U.S. Cl. 49/13; 49/31

(57) ABSTRACT

A controlled gate system for use in a restricted passage having an entry end and an exit end is described. The system comprises a barrier gate secured to a pivotal support assembly at the exit end to permit the barrier gate to pivot from a closed position, obstructing the restricted passage, to an open position, outwardly of the restricted passage to permit entry into an establishment. An electrically actuable brake, arrests the gate at the closed position and it is deactivated by a detector activated by a person at the entry end. An electromagnetic arresting mechanism is provided to disconnect the barrier gate from the electrically actuable brake to permit the barrier gate to swing freely within and out of the passage to provide for evacuation in emergency situations.

### TECHNICAL FIELD

The present invention relates to a controlled gate system for use in a restricted passage having an entry end and an exit end with a barrier gate provided at the exit end and wherein mechanisms are provided to permit evacuation from inside an establishment through the restricted passage by automatically disconnecting the barrier gate causing it to swing freely.

### BACKGROUND ART

Reference is made to our related U.S. patent application Ser. No. 12/471,440, filed on May 25, 2009, and entitled “Gate System With Automatic Locking And Unlocking Feature”, which describes a controlled gate system with automatic locking and unlocking features. These controlled gate systems with restricted passage are installed at the entry doors of an establishment and in many cases, are located far from the exit doors where the checkout counters and registries are located. It is at the exit end of an establishment, such as grocery and other merchandising shopping establishments where the majority of employees are located. Accordingly, theft or illegal exit from the establishment occurs at the entry end where, for example, a person can jump the barrier gates or an adjacent fence with stolen goods. Also a person inside the establishment can pass merchandise to another person who is in the passageway in front of the barrier gate to steal merchandise.

There is also a need, in emergency situations such as during afire alarm, or other emergency situations to disconnect the barrier gate at the entry and of an establishment to permit evacuation from the establishment. These emergency situations are usually controlled by designated personnel of the establishment who have keys to unlock the barrier gates. There is also a need for unlocking the barrier gate locally by anyone by actuating panic switch means on the barrier arm which at the same time produce audible and/or visual alarms to signal to others that the switch means has been activated and the gate opened.

### SUMMARY OF INVENTION

It is a feature of the present invention to provide a controlled gate system which satisfies the above-referenced needs and overcome the above-mentioned disadvantages.

Another feature of the present invention is to provide a controlled gate system which has an electrically actuable arresting means to prevent the controlled gate from being displaced inward of a restricted passageway under normal conditions and wherein an electromagnetic mechanism is automatically actuable to permit the barrier gate to swing inwardly into the passageway during predetermined detected events by a control circuit.

According to another feature of the present invention there is provided a panic switch associated with the barrier arm on the barrier gate to disengage the barrier gate and simultaneously generate an alarm condition.

According to the above features, from a broad aspect, the present invention provides a controlled gate system for use in a restricted passage having an entry end and an exit end. The system comprises a barrier gate secured to a pivotal support assembly at the exit end to permit the barrier gate to pivot from a closed position, obstructing the restricted passage, to an open position, outwardly of the restricted passage. Electrically actuable arresting means lock the barrier gate at the closed position. Detection means detects the presence of a person at the entry end. Control circuit means is provided for receiving an entry signal from the motion detection means to condition the electrically actuable arresting means to unlock the barrier gate during a predetermined time period after receiving the entry signal to permit passage through the barrier gate. Electromagnetic connection means is provided to connect the barrier gate to the pivotal support assembly. Disconnect means is provided to disengage the electromagnetic connection means and the electrically actuable arresting means to permit the barrier gate to pivot outwardly and inwardly of the restricted passage to permit passage from the exit end to the entry end and vice-versa during predetermined detected events by the control circuit means.

### BRIEF DESCRIPTION OF DRAWINGS

A preferred embodiment of the present invention will now be described with reference to the accompanying drawings in which:

FIG. 1 is a perspective view showing a controlled gate system constructed in accordance with the present invention;

FIG. 2 is a perspective view of a barrier gate constructed in accordance with the present invention and secured at an exit end of a restricted passage;

FIG. 3 is a perspective view of a stationary vertical shaft as used in the pivotal support assembly described herein;

FIG. 4 is an enlarged view showing the relationship of a slope formation secured at the top end of the stationary vertical shaft and disposed in frictional contact with a stationary ramp formation held captive inside a vertical tubular support member;

FIG. 5 is a simplified, partly sectioned view, showing the construction of the barrier arm secured to the vertical tubular support assembly and illustrating the position of the electromagnet assembly;

FIG. 6 is a perspective view of the bottom support bracket assembly which is provided with a solenoid which operates an arresting latch and constituting an electrically actuable arresting means for the barrier gate;

FIG. 7 is a further perspective view of the bottom support bracket with the solenoid and latch showing the arresting latch in a disengaged position;

FIG. 8 is a simplified diagram showing the construction of the pivotal support assembly of the barrier gate of the present invention as seen from inside the passageway;

FIG. 9A is a simplified cross-section view showing the pivotal support assembly when the barrier gate extends in a closed position;

FIG. 9B is a cross-section view similar to FIG. 9A but showing the barrier gate in an emergency exit position where the barrier gate is displaced inwardly of the restricted passageway;

FIG. 9C is a simplified top view of the pivotal support assembly showing the construction of the arresting element secured to the first vertical tubular support member to prevent the barrier gate to be displaced rearwardly within the restricted passageway during normal operation of the barrier gate;

FIG. 10 is a block diagram of the control system and its peripheral circuitry, sensors and components;

FIG. 11 is a side view of the barrier gate showing a further embodiment wherein the barrier gate automatically opens during an alarm condition not to obstruct the passageway;

FIG. 12 is a top view of the barrier showing its displacement by the torsion spring; and

FIG. 13 is an enlarged view showing the connection of the torsion spring across the electromagnet and its metal plate.

### DESCRIPTION OF PREFERRED EMBODIMENTS

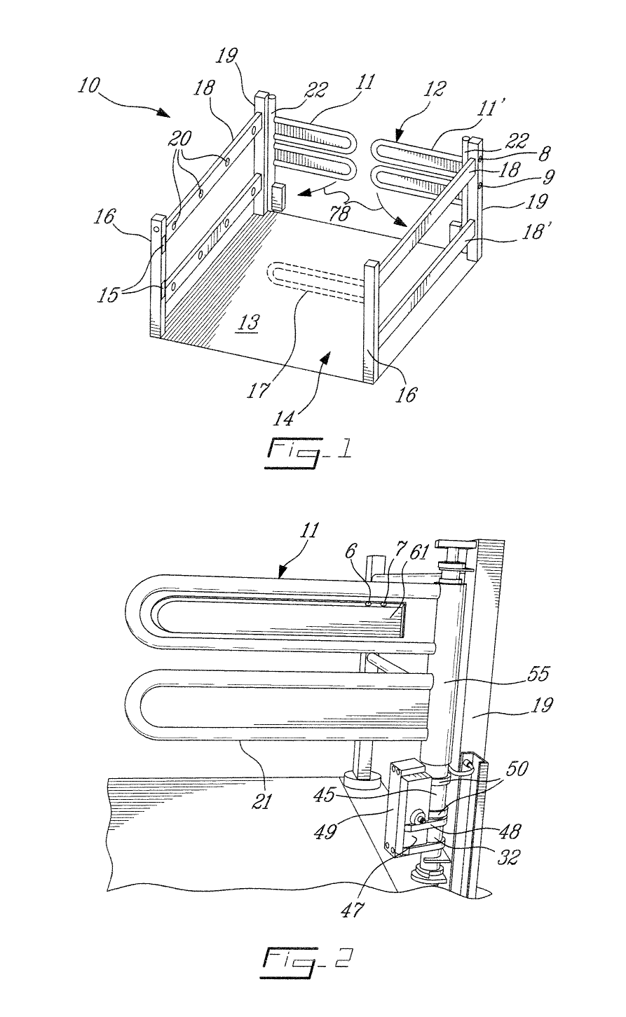

Referring now to the drawings and more particularly to FIG. 1, there is shown generally at 10 a controlled gate system constructed in accordance with the present invention. The controlled gate system as herein illustrated is comprised of two barrier gates 11 and 11′ secured in side-by-side alignment at an exit end 12 of a restricted passageway 13 defined between an entry end 14 and the exit end 12. The controlled gate system is installed in an establishment next to the entry doors thereof (not shown). Although the controlled gate system herein illustrated has two barrier gates 11 and 11′, it is contemplated that it may have a single gate 11 and operate in the same fashion as described herein.

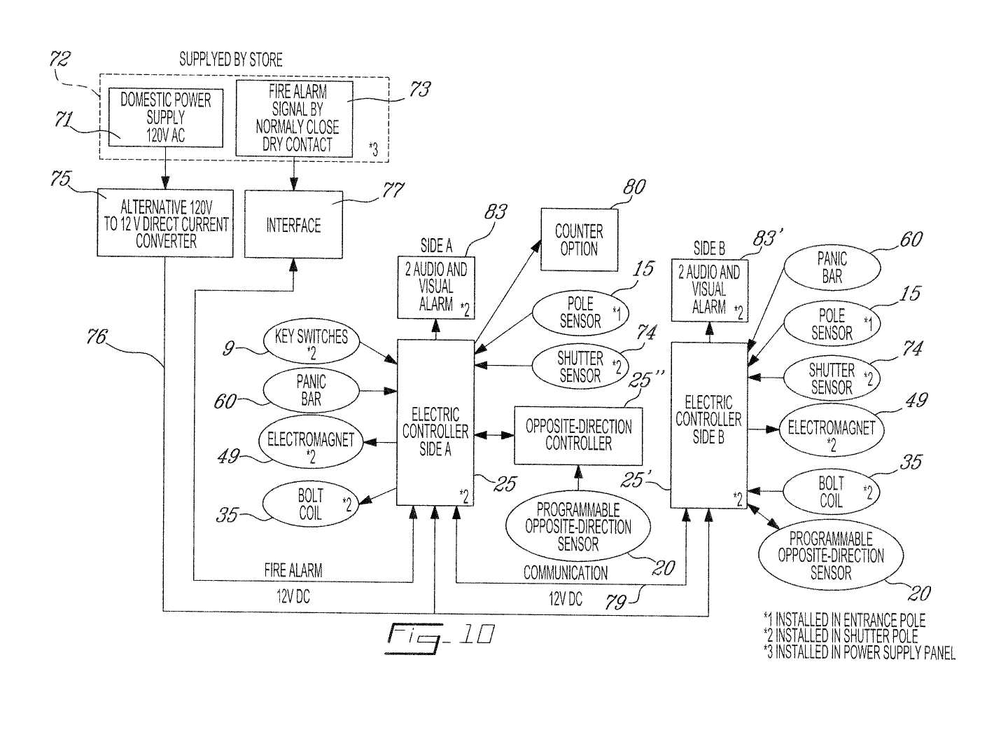

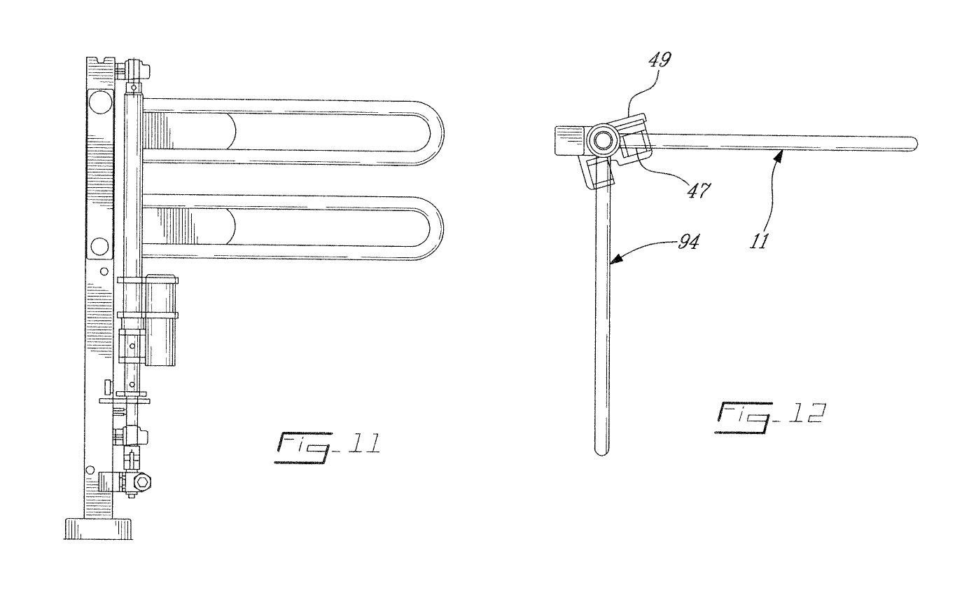

Motion detectors are provided at the entry end 14 and may be comprised of electronic motion detectors 15 using logic to detect the presence of a person. The detector is disposed within vertical posts 16 at the entry end of the passageway. The motion detector may also consist of pivotal gates 17, herein shown in phantom lines, which upon displacement thereof, transmits an entry signal to a control circuit 25, as shown in FIG. 10. It is also foreseeable that in certain applications where the control gate is used to provide passage of authorized personnel only, such as in airports, the detector at the entry end 14 may consist of ID card readers. Authorized ID cards would be programmed and permit passage through the exit end 12.

A key cylinder 9 is provided a post 19 and is operable by a key to activate or deactivate the system. An LED (light emitting diode) light 8 indicates the operative condition of the system.

As hereinshown, top and bottom side horizontal bars 18 and 18′, respectively, are secured to the vertical post 16 at the entry end and the vertical post 19 at the exit end of the restricted passage. A plurality of electronic motion detectors 20 are secured in the bottom side horizontal bar 18′, and could also be secured in the top bar 18, to detect the direction of displacement of a person entering into an establishment from the entry end 14 to the exit end 12. These motion detectors 20 detect the movement of a person in a direction towards the barrier gates 11 and 11′. Once a person has passed through the barrier gates and no one is in the restricted passage, the gates relock in their closed position. If the gates are maintained opened by the person entering the establishment and no one is in the restricted passage, an alarm is actuated. The alarm stops when the gates are re-closed after a time delay. The alarm is both visual and audible. If the detectors 18 are on both sides of the restricted passageway and detect a motion in the reverse direction, then an alarm is sounded indicating that a person has entered into the restricted passageway and exited the passageway through the entry end of the passageway before entering the establishment indicating a possible theft situation. If the person enters the passageway and exits the passageway prior to reaching a certain number of detectors 20, for example three of them and decides to exit through the entry end, then an alarm will not be sounded as this is an indication that a person has decided not to enter into the establishment. The distance between the entry end and the motion detector permitting exit to the entry end is such as to prevent another person into an establishment being capable of passing goods to that person inside the restricted passage. These detectors also prevent a person from jumping over the gates 11 and 11′ or crawling under them. It can also detect a situation where a person exits the restricted passageway 13 as a person enters the passageway.

As illustrated in FIG. 1 there are two barrier gates 11 and 11′ and these are constructed and supported identically to one another. Accordingly only one of these will be described herein and the same applies to the motion detectors in the vertical posts 16 at the entry end. With respect to the motion detectors, it is noted that detectors 15 are provided at two levels to ascertain that indeed it is a person that is entering into the restricted passageway.

Each of the barrier gates is provided with a pivotal support assembly as described in detail in our aforementioned U.S. Patent Application and will again be described but only briefly herein with reference to FIGS. 3 to 7. As shown in FIG. 3, the pivotal support assembly 22 comprises a stationary vertical shaft 26 which is immovably secured at a bottom end 27 in a support bracket 28, see FIG. 6, and at a top end secured in attachment bracket 29. A threaded bore 30 provides for the immovable securement. A stationary ramp formation 31 is immovably secured to the stationary vertical shaft 26.

A first vertical tubular support member 32 is axially rotatable about the stationary vertical shaft 26 and has a ramp follower member 33 secured thereto by welding 34 or solider whereby when the first vertical tubular support post is axially rotated, the ramp follower member 33 will slidingly engage stationary ramp formation 31 immovably secured to the shaft 26 and will cause the support 32 to move upwardly and fall back to it initial position by gravity when the barrier arm 21 of the gate is released by a person entering an establishment through the passageway 13. The initial position of the barrier arm 21 is normally in a closed position as shown in FIG. 1, transverse to the passageway 13 preventing entry into the establishment. The operation of the ramp system is clearly described in my afore-mentioned U.S. Patent Application.

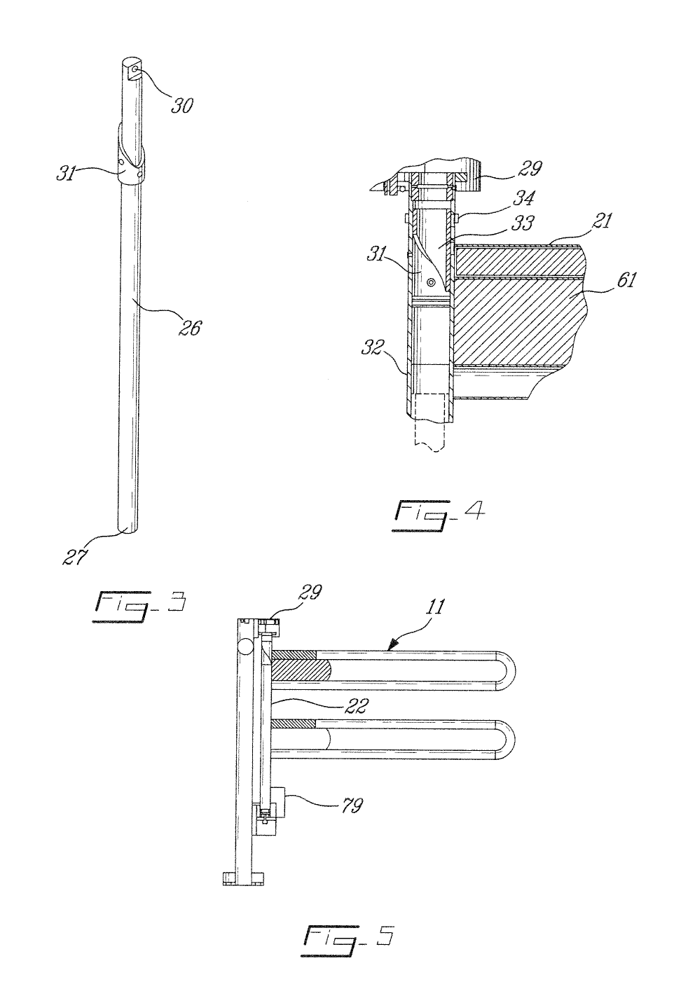

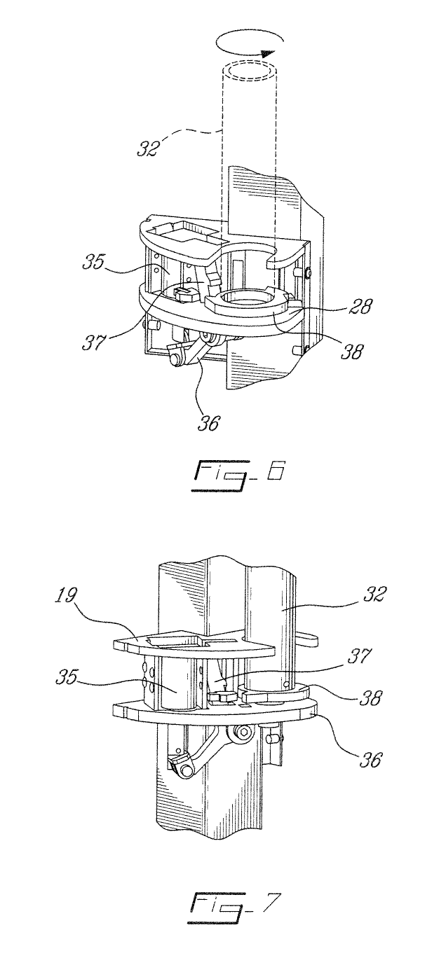

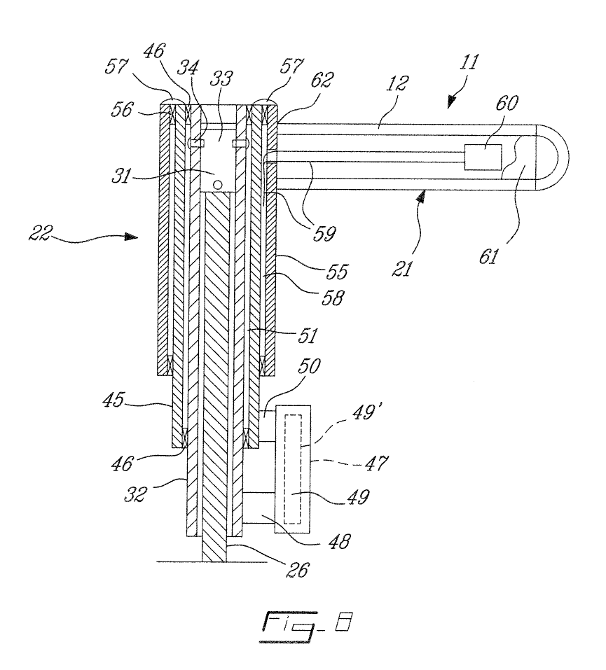

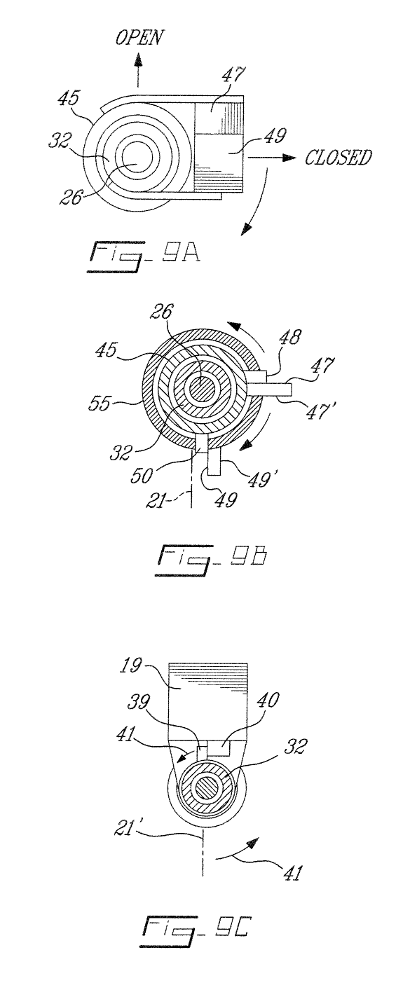

With reference now to FIGS. 6 and 7, there is illustrated an electrically actuable arresting means secured on the support bracket 28 and it is comprised of a solenoid 35 which operates a latch linkage 36 to displace an arresting latch finger 37 from an engaged position to a disengaged position whereby to arrest the first vertical tubular support member 32 during a normal obstructing position where no one has entered into the restricted passageway. As hereinshown, the first vertical tubular support member 32 is provided with a stopper ring 38 at a lower end thereof which is engageable by the arresting latch 37 of the solenoid 35. As soon as a person enters into the restricted passageway and its presence is detected by the motion detectors 15 or 17, the solenoid is operated by the control circuit to disengage the latch from the first vertical tubular support member 32 causing that member to rotate axially but only in the direction from its closed position, as shown in FIG. 1, to a position outwardly of the restricted passageway in a direction of arrow 41 inside the establishment, as illustrated in FIG. 9C. As shown in FIG. 9C, the first vertical tubular support member 32 is provided with an arresting element such as a steel projecting finger 39 extending horizontally therefrom and disposed to abut against a stopper member 40 secured to a stationary element, herein the vertical support post 19, whereby to prevent the barrier arm 21, represented by the phantom line 21′, from swinging inwardly within the passageway. Accordingly, the inner vertical tubular support member 32 can only swing outwardly in the direction of arrow 41.

As shown in FIG. 8, the pivotal support mechanism 22 is further comprised with a second vertical tubular support member 45 axially rotatable about the first vertical tubular support member 32 and spaced therefrom by bushings 46. An electromagnet 49 of an electromagnetic disconnect means is secured to the first vertical tubular support member 32, at a lower end thereof, by suitable connecting means such as bracket 50. An armature member 47, see FIG. 9B, is secured to the first vertical tubular support member 32 and is aligned for facial displacement with the electromagnet 49 and this is illustrated by phantom line in FIG. 8. The electromagnet 49 is secured to the second vertical tubular support member 45 by suitable means such as bracket 50 welded thereto as mentioned above. As hereinshown, both the steel plate 47 and the electromagnet 49 have a flat contact surface 47′ and 49′, respectively, oriented vertically for juxtaposition with one another when the electromagnet is energized by an electrical supply connected to the electromagnet 49 through switch means (not shown but obvious to a person skilled in the art) operated by the controller 25, as shown in FIG. 10. The wiring for the electromagnet 49 is disposed within the annular space 51, as shown in FIG. 8, between the first and second vertical tubular support members. The electromagnet 49 is normally energized thereby connecting the first and second vertical support members together by its magnetic engagement with the armature member 47 During normal operation, the electromagnet is energized and moves with the tubular member 32 and 45 as the gate 21 swings from its closed position to its open position, as shown in FIG. 9A. During emergency situations or events, the switch means operated by the controller 25 will be operated to disconnect or cut-off the electrical supply to the electromagnet 49 and the solenoid 35 thereby disconnecting the first and second vertical tubular support members from one another permitting the gate 21 to swing in and out of the passageway 13. FIG. 9B shows the electromagnet and the gate 21 displaced inside the passageway 13. However, the armature member 47 connected to the first tubular member 32 cannot be displaced inwardly due to the arresting element 39 but will swing outwardly in the direction of arrow 41 due to the fact that the latch of the electromagnet is disengaged.

As also shown in FIG. 8, there is further provided a third external vertical tubular member 55 which is immovably secured to the second vertical tubular support member and spaced therefrom by spacing bushings 56. The external vertical tube is immovably secured by welds 57 or other suitable means. This third vertical tubular member is provided to create an internal passageway 58 by the annular space between the third external vertical tubular member 55 and the second vertical tubular support member 45 whereby wiring 59 can extend therethrough and be concealed. As illustrated, the vertical tubular members are shown as being of different lengths to accommodate the displacement of the electromagnet. However, the third tubular member 55 in reality extends much lower and has openings to permit displacement of the bracket 50 when the gate is displaced inwardly in the restricted passage, and the passage of the bracket 48.

The wiring 59 as hereinshown is that of an emergency exit switch assembly 60 which is actuated by depressing an emergency exit instruction panel 61 formed of flexible plastic material or other suitable material and secured to the barrier arm 21 of the barrier gate 11. As shown in FIG. 2, this panel 61 is secured to the barrier arm 21 and accessible and actuable exteriorly of the barrier gate 11 inside an establishment. The emergency exit switch 60′ is connected to the controller 25 which actuates a timer. The switch panel must remain depressed for three seconds and upon expiration of this time delay stored in the memory 81 of a microprocessor 82 of the controller 25 and a visual and audible alarm 83 will sound and flash. The timer continues its count for a remaining 15 second delay and disengages the barrier gates 11 and 11′, as illustrated in FIG. 1. Accordingly, the control circuit operates a switch means to disconnect the electrical supply to the electromagnet 49 and solenoid 35 causing the barrier gate 21 to pivot freely about the vertical shaft 26 with the first vertical tubular support member 32 having been disconnected from the solenoid and the disconnection of the electromagnet 49 with the armature member 47 being displaceable with the member 32, permitting the barrier gate 11 to swing into the restricted passage towards the entry and 14 to permit evacuation from the establishment through the restricted passageway 13. It is pointed out that in order for the controller 25 to detect an evacuation alarm signal, it is necessary that the panel 61 in the barrier arm 21 be maintained depressed for a short programmed period of time, herein 3 seconds, in order for the control circuit to establish an alarm condition at the gate. This prevents accidental operation of the alarm panel. As illustrated in FIG. 8, the barrier gate 11 is immovably secured to the third external vertical tubular member by weld connection 62 or other suitable connecting means.

As shown in FIG. 2, two LED lamps 6 and 7 are mounted on the panel 61 of the barrier arms 21. One LED lamp 6 is a green LED and when lit designates that the barrier gate has been deactivated thus requiring a key to be inserted in the key cylinder 9 to reactivate the system. The other LED 7 is a red LED and when lit indicates that the gate was open but is not in the proper closed position and must be displaced for the magnet to lock. A position switch (not shown) in FIG. 2, detects the position of two adjacent tubular support members 55 and 45 to indicate if the barrier arm 21 is in the closed position and lights the LED 7 when not in position. After 10 seconds, audible beeps will sound to inform people to place the gate back in the locked position, i.e., magnet engaged. When the red LED 7 flashes, it is an indication that the gate is in the proper closed position. When it is “ON” and not flashing, it indicates that the gate is not in the closed position and the electromagnet needs to be reactivated.

It is also pointed out that if the gate 11 or 11′ is forced open by a person overpowering the magnetic retention force of the electromagnet 49, the control system will operate the alarms 83 during one minute and automatically reactivates itself after that time delay. The gate may then have to be re-closed if it has not done so by itself. The alarm condition can also be stopped by placing a key in the key cylinder 9 to reset the system.

In order to manually deactivate the system, it is necessary to place a key in the key cylinder 9 and position it in the horizontal position. When the system is deactivated, the LED 8 in the vertical post 19 is lit and the green LED 6, see FIG. 2, on the panic panel 61 is lit. The gates 11 and 11′ can then be open in both directions. In order to reactivate the system, it is necessary to turn the key in the cylinder to the vertical position. When the system is armed, the LEDs 8 in the vertical post 16 are not lit but the red LEDs 6 on the panic panel 61 will flash. If the LEDs on one or both of the panels 61 remain lit and do not flash, it is an indication that the barrier gates 11 or 11′ are not in their closed position and it is therefore necessary to simply pull the gates back in such a way to engage the electromagnets. However, if one of the gates is not in position after a delay of about 10 seconds after the system has been armed, an audible alarm will sound in one of the posts 19 associated with the gate that is not in the proper closed position and this alarm will stop after the gate is placed back to its proper closed position. It is pointed out that when the system is armed both gates are locked and cannot be displaced in either an inward or outward position with respect to the passageway.

With reference to FIG. 10, it is pointed out that when there is an alarm condition in the central alarm system 73, the gates automatically disengage instantly and the arms can be swung in either direction to permit evacuation. In order to reactivate the system after such an alarm, it is necessary that the central alarm system be deactivated and that a key be placed in the key cylinder with the key slot in a horizontal position and brought back to the vertical position in order to reset the system. Thereafter, the key is displaced through its armed horizontal position.

It is also pointed out that when there is an electrical power failure, the gates also automatically unlock and the gates can swing in either direction. Once the power is reestablished, the gates reactivate themselves automatically after a five minute time delay programmed to automatically reactivate themselves. It is possible that in such a situation that the gates may have to be manually repositioned to their closed position if they are still in an open position. It is also possible to manually reactivate the system by placing a key in the cylinder and resetting the system as above-described.

When the system is deactivated by the key cylinder, the LED lamp 8 on the respective posts 19 is permanently lit. If the system has been deactivated by a fire alarm, this LED lamp 8 will have one pulsation at intervals. If the system is deactivated by a power failure, then the lamp will have two pulsations at intervals. In a situation where the system has been deactivated by the panic switch or panel 61 having been depressed, the LED lamp 8 will have three pulsations at intervals but will only be activated after a delay of a minute. When the light has four pulsations at intervals it indicates that there is no supply to either the coils 35 or the electromagnets 49 and a verification of their connection is therefore necessary. When this LED lamp 8 pulsates five times at intervals, it indicates that there is a loss of communication between the two controllers associated with the two gates 11 and 11′. When such a situation occurs, the gates are automatically deactivated and a verification of the wiring between the two controllers is necessary. In all of these error codes generated by the LED lamps 8, it is necessary to reset the system by the use of the key in the key cylinder.

With reference to FIG. 10, it can be seen that the key-operated cylinder 9 is connected to the control circuit 25 which upon actuation by a key under the control of designated personnel, causes the control circuit to open the switch means to cut-off the electrical supply to the electromagnet and solenoid to permit the barrier gate to pivot freely for evacuation through the restricted passage. It is pointed out that there are two controllers 25 and 25′ each associated with a respective one of the gates 11 and 11′ and a controller 25″ which receive signals from the detectors 20 to control the gates and the alarm dependent on the sequence of the signals received from the detectors 20 indicative of the activity or motion of one or more persons in the restrictive passage. The controllers 25 and 25′ communicate with one another through a link line 79. Controller 25″ communicates with the controller of gate 11 as the detectors 20 are provided on one side only of the restricted passage. The key-operated cylinder 9 is mounted in a secured box attached to one of the support posts at the exit end of the restricted passage. Also, the controller 25, 25′ is connected to the electrical supply 75 of the establishment and upon a power failure condition, power is automatically cut-off from the electromagnets 49 and the solenoids 35 to permit evacuation. The establishment, herein represented by the block reference number 72, has a central alarm system 73 which is permanently connected through an NC contact or other switch means directly to the controller 25, 25′ whereupon detection of a general alarm or other alarm conditions causes the controller 25, 25′ to operate the switch means to cut-off the electrical supply to the electromagnets and solenoids. As hereinshown, the power supply 71 of the establishment is connected to an AC to DC converter 75 to feed a supply of 12 volts to the controller 25, 25′ through the supply line 76. As also shown in FIG. 10, a position sensing switch 74 is provided to detect the position of both barrier gates 11 and 11′ to inform the control circuit 25, 25′ of their closed or open positions. Audible and visual alarms 83 and 83′ are mounted in respective posts 19 of the gates 11 and 11′.

As previously described and illustrated in FIG. 1, the barrier gates 11 and 11′ can only be swung internally of the passageway as shown by arrows 78 when the electromagnets 49 are de-energized. As shown in FIG. 1, the electromagnets 49 of the gates are located in housings 79 at the base of the pivot support assembly 22.

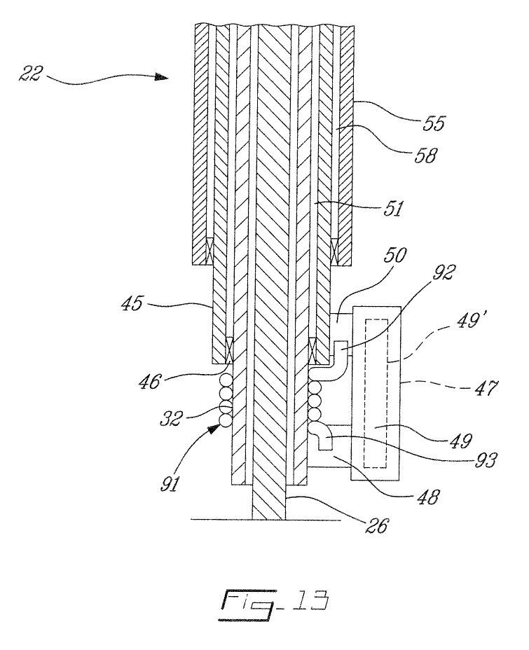

Referring now to FIGS. 11 to 13, there is shown a further embodiment of the present invention wherein the barrier gate 11 automatically assumes an open position when there is an alarm condition, As hereinshown, the pivotal support assembly 22 does not include the gravity return mechanism as illustrated in FIGS. 3 to 5. Other suitable gate return systems, herein schematically illustrated at 95, can be used to return the gate to its closed position during normal operation of the gate 11. As hereinshown, the pivotal support assembly 22 is pivotally retained between a pair of pillow blocks 90 and 90′ secured respectively to the vertical post 19. For emergency conditions, a torsion spring 91 is disposed about the first vertical tubular support post 32 with a first end 92 of the torsion spring 91 being secured to the bracket 50 of the electromagnet 49 and the second end 93 of the torsion spring being connected to the plate 48 of the steel plate 47. The force of the torsion spring 91 is selected to be overpowered by the force of the electromagnet when energized but when de-energized has sufficient restoring force to move the barrier gate 11 from its closed normal position as shown in FIG. 12, to its open position 94 as thereinshown wherein the gate does not intrude within the passageway.

It is within the ambit of the present invention to cover any obvious modifications of a preferred embodiment described herein provided such modifications fall within the scope of the appended claims. For example, detectors may also be mounted on the posts 16 and/or 19 slightly above the floor to prevent passage of objects slid under the gates 11 and 11′. Further detectors or programmed functions may be incorporated in the system to count the number of persons that have passed through the restricted passage and also the number of shopping carts.

1. A controlled gate system for use in a restricted passage having an entry end and an exit end, said system comprising a barrier gate secured to a pivotal support assembly at said exit end to permit said barrier gate to pivot from a closed position, obstructing said restricted passage, to an open position outwardly of said restricted passage; electrically actuable arresting means to lock said barrier gate at said closed position, detection means to detect the presence of a person at said entry end, control circuit means for receiving an entry signal from said motion detection means to condition said electrically actuable arresting means to unlock said barrier gate during a predetermined time period after receiving said entry signal to permit passage through said barrier gate, electromagnetic connection means to connect said barrier gate to said pivotal support assembly and disconnect means to disengage said electromagnetic connection means and said actuable arresting means to permit said barrier gate to pivot outwardly and inwardly of said restricted passage to permit passage from said exit end to said entry end and vice-versa during predetermined detected events by said control circuit means.

2. A controlled gate system as claimed in claim 1 wherein said pivotal support mechanism comprises a stationary vertical shaft supported at both ends by a fixed support, a first vertical tubular support member axially rotatable about said stationary vertical shaft, an electromagnet secured to said first vertical tubular support member and displaceable therewith, a second vertical tubular support member axially rotatable about said first vertical tubular support member, an armature member secured to said second vertical tubular support member and aligned for facial displacement with said electromagnet, an electrical supply connected to said electromagnet for energizing same for locking engagement with said armature thereby interconnecting said first and second vertical tubular support members together, said barrier gate being secured to said second vertical tubular support member.

3. A controlled gate system as claimed in claim 2 wherein said electrical supply is connected to said electromagnet through switch means operated by said control circuit, said switch means being actuated to an open condition to cut-off said electrical supply during said predetermined detected events.

4. A controlled gate system as claimed in claim 2 wherein said armature member is a steel plate secured to a lower end of said second vertical tubular support member and disposed in a vertical plane, said steel plate having a flat contact surface, said electromagnet also having a flat contact surface oriented vertically for juxtapositioning against said flat contact surface of said steel plate when said barrier gate is at said closed position.

5. A controlled gate system as claimed in claim 3 wherein said barrier gate is provided with an emergency exit switch secured therewith and actuable exteriorly of said barrier gate from inside an establishment, said emergency exit switch being connected to said control circuit means which actuates a timer which upon expiration of an emergency time delay stored in a memory of a microprocessor of said control circuit means activates an audible alarm and operates said switch means to disconnect said electrical supply to said electromagnet and said actuable arresting means causing said barrier gate to pivot freely within said restricted passage towards said entry end to permit exit from said establishment and outwardly of said exit end.

6. A controlled gate system as claimed in claim 5 wherein said barrier gate comprises at least one barrier arm assembly extending horizontally from said second vertical tubular support member, said emergency exit switch being actuated by depressing an emergency exit instruction panel containing instructions and secured to said at least one barrier arm assembly, said panel being maintained depressed for a short programmed period of time in order for said control circuit means to detect an alarm condition and operate said switch means after a programmed time delay to disconnect power to said electromagnet and actuable arresting means.

7. A controlled gate system as claimed in claim 2 wherein there is further provided a third external vertical tubular member immovably secured to said second vertical tubular support member, said first and second vertical tubular support members being independently axially rotatable from one another when said electromagnet and actuable arresting means are de-energized.

8. A controlled gate system as claimed in claim 7 wherein said barrier gate is welded to said third external vertical tubular member, spacer bushings provided between said third external vertical tubular member and said second vertical tubular support member to form an annular chamber therebetween for the passage of wiring associated with an emergency exit switch provided in said barrier gate.

9. A controlled gate system as claimed in claim 1 wherein said detection means is one of an electronic motion detector, an ID card reader or a switch operating pivotal barrier arm secured to support means at said entry end of said restricted passage.

10. A controlled gate system as claimed in claim 1 wherein said actuable arresting means is a solenoid actuated latch which is displaceable to engage a bottom support bracket of said first vertical tubular support member to prevent axial rotation thereof.

11. A controlled gate system as claimed in claim 5 wherein there is further provided a key operated cylinder electrically connected to said control circuit means which upon actuation by a key causes said control circuit means to reset or open said switch means to cut-off said electrical supply to said electromagnet and said actuable arresting means to permit said barrier gate to pivot freely within said restricted passage towards said entry end or out of said restricted passage to permit free passage through said restricted passage, said electromagnet being secured at a lower end of said first vertical tubular support member on an inward side of said restricted passage.

12. A controlled gate system as claimed in claim 5 wherein said control circuit means is further connected to an electrical supply of said establishment and upon a power failure condition automatically causes said switch means to cut-off said electrical supply to said electromagnet and said actuable arresting means to permit said barrier gate to pivot freely within said restricted passage towards said entry end or out of said restricted passage to permit free passage through said restricted passage.

13. A controlled gate system as claimed in claim 5 wherein said control circuit means is further connected to an alarm system of said establishment and upon actuation of an alarm condition thereof said control circuit means causes said switch means to cut-off said electrical supply to said electromagnet and said actuable arresting means to permit said barrier gate to pivot freely within said restricted passage towards said entry end or out of said restricted passage to permit free passage through said restricted passage.

14. A controlled gate system as claimed in claim 5 wherein there is further provided a visual alarm triggered simultaneously with said audible alarm.

15. A controlled gate system as claimed in claim 1 wherein said control circuit means is a microprocessor having a readable memory having recorded therein statements and instructions for execution by a computer, and a timer circuit associated with said computer.

16. A controlled gate system as claimed in claim 2 wherein said first vertical tubular support member is provided with an arresting element to prevent said barrier gate to be displaced rearwardly within said restricted passage during normal operation of said barrier gate with said electromagnet energized.

17. A controlled gate system as claimed in claim 1 wherein there is further provided two or more displacement motion detectors between said entry end and said exit end to detect the direction of displacement of a person moving in said restricted passage, said displacement motion detectors being connected to said control circuit means to detect unwanted displacement of said person in said restricted passage.

18. A controlled gate system as claimed in claim 5 wherein there are two of said barrier gates secured in aligned side-by-side relationship at said exit end, each gate having said electrically actuable arresting means and an associated control circuit means, said control circuit means of each said barrier gates being in communication with one another, each said barrier gates having said electromagnetic disconnection means, said control circuit means operating said two barrier gates in coordination with one another, each said barrier gates having one of said emergency exit switch.

19. A controlled gate system as claimed in claim 16 wherein said pivotal support mechanism comprises a stationary vertical shaft supported at both ends by a fixed support, a first vertical tubular support member axially rotatable about said stationary vertical shaft, an electromagnet secured to said first vertical tubular support member and displaceable therewith, a second vertical tubular support member axially rotatable about said first vertical tubular support member, an armature member secured to said second vertical tubular support member and aligned for facial displacement with said electromagnet, an electrical supply connected to said electromagnet for energizing same for locking engagement with said armature thereby interconnecting said first and second vertical tubular support members together, said barrier gate being secured to said second vertical tubular support member, said electrical supply when cut-off disengaging said electromagnet and said actuable arresting means whereby said gate can be displaced outwardly due to the disengagement of said actuable arresting means and inwardly within said restricted passage due to the disengagement of said electromagnet.

20. A controlled gate system as claimed in claim 2 wherein there is further provided barrier gate displacement means secured between said electromagnet and said armature member to automatically displace and retain said barrier gate at said open position when said disconnect means disengages said electromagnet connection means.

21. A controlled gate system as claimed in claim 20 wherein said barrier gate displacement means is a torsion spring disposed about said pivotal support assembly, said torsion spring having a first end secured to said armature member and a second end secured to said electromagnet, said torsion spring having a predetermined force for biasing said electromagnet and said armature member away from one another when said electromagnet is de-energized, said electromagnet when energized overcoming said predetermined biasing force to maintain said barrier gate at said closed position.
